(19) United States
(12) Patent Application Publication
(10) Pub. No.: US 2026/0239217 A1
(43) Pub. Date: Aug. 13, 2026

(54) COMMUNICATION MANAGEMENT IN ENDPOINT DEVICES

(71) Applicant: Sensus Spectrum, LLC, Morrisville, NC (US)

(72) Inventor: Adam Hansen, Cary, NC (US)

(21) Appl. No.: 19/048,426

(22) Filed: Feb. 7, 2025

(51) Int. Cl. H04W 52/02; H04W 28/02; H04W 48/20; H04W 76/28

(52) U.S. Cl. CPC H04W 52/0241; H04W 28/0205; H04W 48/20; H04W 76/28

(57) ABSTRACT

Systems and methods for managing communication in resource-constrained endpoint devices are described. A communication framework can integrate a shared synchronization interval with assigned targeted communication intervals within periodic communication cycles. Endpoint devices can synchronize during the shared interval and activate their receivers during assigned targeted intervals to receive transmissions, thereby balancing energy consumption and communication efficiency.

### FIELD

The present disclosure generally relates to communication protocols in networked systems, and more particularly, to systems and methods for scheduling communication in battery-powered endpoint devices operating within resource-limited environments.

### BACKGROUND

Endpoint devices, such as utility meters and remote monitoring units, can be deployed in networked systems for applications like data collection, monitoring, and control. These endpoint devices often operate with resource constraints, such as limited power availability or communication bandwidth, which can influence their design and operation.

Some networked systems use a communication protocol, such as middle-of-minute (MoM) communication, that involves assigning a predefined, fixed communication time slot within a recurring communication cycle that is the same for all endpoints participating in the timed, synchronous reception. During this shared time slot, endpoint devices activate to receive transmissions, aligning their internal clocks with the network's timing and detecting transmissions, such as synchronization signals or operational commands. Outside of this shared time slot, the receivers often remain inactive, conserving power and supporting efficient operation for endpoint devices with constrained energy resources.

While MoM communication provides a structured framework, its reliance on a single fixed communication time slot per communication cycle can limit the number of commands transmitted, as only one message can typically be sent to avoid conflicts or overlapping transmissions. This limitation can challenge scalability and responsiveness in systems with a large number of endpoint devices or varying communication demands.

### SUMMARY

Systems and methods for managing communication in resource-constrained endpoint devices are described. A communication framework can integrate a shared synchronization interval with assigned targeted communication intervals within periodic communication cycles. Endpoint devices can synchronize during the shared interval and activate their receivers during assigned targeted intervals to receive transmissions, thereby balancing energy consumption and communication efficiency.

### BRIEF DESCRIPTION OF THE DRAWINGS

Throughout the drawings, reference numbers can be re-used to indicate correspondence between referenced elements. The drawings are provided to illustrate embodiments of the present disclosure and do not limit the scope thereof.

FIG. 1 illustrates a block diagram of a communication system for managing synchronization and communication in networked endpoint devices.

FIGS. 2A through 2C illustrate examples of a periodic communication cycle, in accordance with the inventive concepts.

FIG. 3 presents a flow diagram illustrating an embodiment of a routine implemented by the endpoint device of FIG. 1.

### DETAILED DESCRIPTION

Communication and synchronization in networked systems may play an important role in supporting the operation of endpoint devices. Endpoint devices can be deployed in resource-constrained environments and, in some cases, may be battery-operated. Such endpoint devices frequently rely on structured communication frameworks to maintain synchronization with network timing and receive operational commands. One method, MoM communication, involves assigning a shared fixed communication time slot during which all endpoint devices of a group (e.g., those endpoints participating in the timed, synchronous reception) activate to receive transmissions. While this approach can support synchronization, it may present challenges in scalability and responsiveness, particularly in networks with a large number of endpoint devices or dynamic communication requirements.

Some inventive concepts described herein relate to the use of additional communication time slots that may be assigned to endpoint devices, such that each endpoint device is assigned one or more of the additional communication time slots. These additional time slots can complement a shared time slot used for synchronization, allowing commands to be sent to individual endpoint devices or smaller groups of endpoint devices during separate time slots, but potentially within the same communication cycle. Such an approach can increase the overall command throughput of the communication system while distributing communication demands more evenly across the network.

Some inventive concepts described herein relate to managing receiver activations to support communication efficiency, which can be beneficial for battery-operated endpoint devices where power efficiency is often an important consideration. Endpoint devices may be activated during their assigned time slots and the shared synchronization time slot, allowing the communication system to communicate with targeted endpoint devices or targeted sub-groups of endpoint devices, while other endpoint devices can remain inactive outside of their designated intervals. This approach can help preserve energy by reducing the overall frequency and duration of receiver activations while ensuring reliable synchronization and command delivery.

Some inventive concepts described herein may address network adaptability. In some cases, the communication system may adjust or reassign time slots based on factors such as network load, endpoint device distribution, or communication demands. For example, if multiple endpoint devices are assigned to a heavily used time slot, the communication system may reallocate some of these endpoint devices to alternative time slots to distribute communication intervals more effectively. Additionally, in some cases, time slots may be assigned based on device type or other relevant characteristics, allowing the communication system to group specific subsets of endpoint devices, such as those servicing commercial or industrial meters, within dedicated timeslots. This grouping could enable the system to send broadcast commands to these subsets during their assigned timeslots, targeting only those devices and avoiding other endpoint types. Such functionality provides an additional advantage over the shared synchronization time slot used today. This flexibility may allow the network to operate efficiently in both steady-state and high-demand conditions.

Some inventive concepts described herein may include retaining a shared synchronization time slot, similar to MoM communication, to ensure consistent timing alignment across all endpoints participating in the timed, synchronous reception. Some or all of the remaining portion of the periodic communication cycle can then be divided into multiple additional time slots, which may be assigned to specific endpoint devices or subsets of the group of endpoint devices. These additional time slots can be used for targeted communication, enabling the communication system to balance synchronization reliability provided by the shared time slot with the ability to transmit a higher volume of commands during the remaining interval. This approach can allow for efficient use of the periodic communication cycle while supporting both network-wide synchronization and endpoint device-specific operations.

Some inventive concepts described herein may provide improvements in communication management for endpoint devices in fields such as utility metering and remote monitoring. By supporting scalable communication, flexible scheduling, and managed receiver activations, these concepts may address the limitations of traditional frameworks and provide practical solutions for managing endpoint devices in resource-constrained environments.

Assigned time slots can improve the scalability and efficiency of communication systems by facilitating targeted transmissions to individual endpoint devices or sub-groups within the network. Unlike traditional methods that rely on a single shared interval for all endpoints participating in the timed, synchronous reception, the inventive concepts can utilize multiple distinct intervals distributed across the communication cycle. This structure can allow the communication controller to transmit multiple messages within the same communication cycle, thereby increasing throughput. Synchronization can still be maintained through the shared interval, enabling those endpoint devices participating in the timed reception to remain aligned with the network's timing framework. By reducing the reliance on the shared interval for individual communications, this system can minimize delays while preserving energy efficiency. In some cases, endpoint devices activate their transceivers only during the shared synchronization interval and their assigned targeted intervals, which can help ensure that energy usage remains low even as the overall system accommodates higher messaging demands.

### Environment Overview

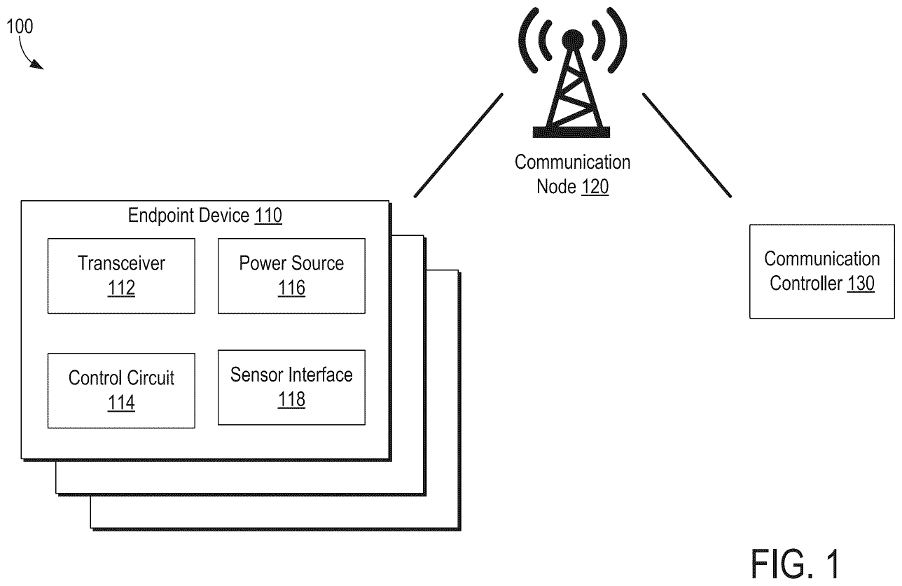

FIG. 1 illustrates a block diagram of a communication system 100 for managing synchronization and communication in networked endpoint devices 110. The communication system 100 includes a plurality of endpoint devices 110, a communication node 120, and a communication controller 130. The communication system 100 may be part of a utility network, such as those used for water, gas, or electricity metering, or other monitoring systems for environmental or industrial applications. To simplify the discussion and not limit the present disclosure, FIG. 1 illustrates only a few endpoint devices 110, one communication node 120, and one communication controller 130, though multiple such components may be used in larger implementations of the communication system 100. For example, the communication system 100 may include tens, hundreds, thousands, or more endpoint devices 110.

The communication node 120 can be configured to transmit communication signals to endpoint devices 110 within the communication system 100. The communication signals can include, but are not limited to, synchronization signals or operational commands. A synchronization signal can facilitate the alignment of the internal clocks of the endpoint devices 110 with a common network time. When an endpoint device 110 receives a synchronization signal, the endpoint device 110 can update its internal clock to match the transmitted network time, allowing the endpoint device 110 to operate in coordination with the periodic communication cycles of the communication system 100. A synchronization signal may include a timing message that conveys the current network time, such as “Network time is 12:00:30.” This timing information can allow the endpoint devices 110 to adjust their internal clocks and remain aligned with the network schedule. Synchronization can support the ability of the endpoint devices 110 to activate their receivers during predefined intervals, such as shared synchronization time slots, to reliably detect transmissions from the communication node 120.

An operational command may include instructions for specific tasks to be performed by the endpoint devices 110 within the communication system 100. Such tasks can include, for example, reporting measurement data, updating configuration settings, or performing diagnostic operations. For instance, an operational command might instruct a water meter to transmit its most recent flow rate data or direct a temperature sensor to adjust its sampling interval. In some cases, an operational command may be addressed to or intended for a specific endpoint device 110 or a group of endpoint devices 110. For example, the operational command may include or reference an address or identifier associated with the intended endpoint device 110. As another example, an operational command may be intended for any endpoint device 110 or group of endpoint devices 110 meeting a specified criterion. For example, the operational command may target all endpoint devices assigned to a particular predefined time interval or operational grouping. In addition, in some cases, operational commands may serve synchronization purposes for endpoint devices, even when the operational command is not specifically directed to the receiving endpoint. This synchronization capability may ensure consistent timing alignment across all participating devices and supports reliable network operations. The endpoint devices 110 can evaluate the operational command's criteria to determine whether they should process the operational command or disregard it.

Endpoint devices 110 that receive the operational command can determine whether it is directed to them by comparing the included address or identifier with their stored information. If an endpoint device 110 determines that the operational command is not directed to it, the endpoint device 110 may disregard the operational command. If an endpoint device 110 determines that the operational command is directed to it, the endpoint device 110 may listen to the operational command and process the associated instructions. In some cases, the identifier or address indicating the target endpoint device may be included at the beginning of the operational command. This structure can allow an endpoint device 110 to quickly determine whether to remain active and listen to the full message. For instance, an endpoint device 110 may keep its receiver on to receive the entirety of the operational command after confirming that the initial identifier matches its stored address or criteria.

In some cases, the communication node 120 may transmit communication signals by broadcasting them to a defined coverage area. For example, any endpoint devices 110 located within this coverage area may receive the communication signals if their receivers are active during the designated communication interval. Such a broadcasting approach can allow the communication node 120 to efficiently reach multiple endpoint devices 110 simultaneously, facilitating synchronization or the delivery of operational commands across the communication system 100. In other cases, the communication node 120 may transmit communication signals directly to a particular endpoint device 110 or set of endpoint devices 110.

The communication node 120 may be implemented as a base station or communication tower comprising a radio access component (e.g., an antenna) configured to transmit and/or receive wireless communications to and/or from one or more endpoint devices 110 and/or the communication controller 130. In some cases, the communication node 120 may include additional components, such as, but not limited to, communication processors or memory elements, for example to manage broadcasting tasks or store scheduling information. Although described as a single communication node, it will be appreciated that the communication node 120 may include multiple communication nodes operating together as a set, providing overlapping coverage areas or distributed responsibilities to enhance network reliability and scalability

In some cases, the communication node 120 can communicate a first communication message during a first predefined time interval within a periodic communication cycle. The first communication message may be similar to the signals used in Message-on-Minute (MoM) communication operations, where transmissions occur at consistent predefined intervals. For example, the first predefined time interval may occur at second 30 of each minute, providing a reliable opportunity for synchronization and initial communication with the endpoint devices 110 in the communication system 100. It will be appreciated that the length and occurrence of the first predefined time interval may vary across embodiments. For example, the first predefined time interval may span one second and recur every minute, or it may be shorter or longer and occur at different frequencies depending on the operational requirements of the communication system 100.

The first communication message transmitted during the first predefined time interval can include a synchronization signal or an operational command. If no operational command is scheduled, the communication node 120 may broadcast a synchronization signal to facilitate the alignment of the internal clocks of the endpoint devices 110 with the network timing. If an operational command is available, it may replace the synchronization signal during the same interval. The endpoint devices 110 may activate their receivers during the first predefined time interval to detect and process the first communication message. Upon receiving the initial part of the first communication message, the endpoint devices 110 can adjust their internal clocks to remain aligned with the network schedule. If the message is determined to be an operational command, relevant endpoint devices 110 may keep their receivers active to listen to and process the full command, determining whether it is directed to them. If the message is a synchronization signal, the endpoint devices 110 may deactivate their receivers after processing the timing information, conserving energy.

In some cases, the transmissions during the first predefined time interval can also provide verification of the operability of the communication node 120, as the endpoint devices 110 may rely on regular transmissions to maintain synchronization. If the endpoint devices 110 do not detect transmissions for a predefined number of consecutive communication cycles, they may assume that synchronization has been lost and cease listening for subsequent transmissions. For example, in some embodiments, if no transmission is received for a duration corresponding to multiple periodic communication cycles, such as several minutes, the endpoint devices 110 may stop attempting to align with the communication node 120 and instead enter a different operational state.

In some cases, the communication node 120 can communicate a plurality of second communication messages during a plurality of targeted communication intervals within the periodic communication cycle. Unlike the first predefined time interval, which may be common to all endpoint devices 110 participating in the timed reception, the targeted communication intervals may be distributed across the remaining duration of the periodic communication cycle and assigned to different subsets of endpoint devices 110. In this way, each targeted communication interval can provide a designated opportunity for the communication node 120 to address a distinct subset of endpoint devices 110.

A targeted communication interval can refer to a predefined time slot within the periodic communication cycle that is assigned to a subset of endpoint devices 110. In some cases, none of the targeted communication intervals overlap, ensuring that the communication node 120 transmits messages to one subset of endpoint devices at a time. During each targeted communication interval, the communication node 120 may transmit second communication messages containing operational commands, such as instructions to report data, update configurations, or perform specific tasks. The endpoint devices 110 assigned to a particular targeted communication interval may activate their receivers during the interval to detect and process the second communication message. For example, if an endpoint device 110 is assigned to second 17, the endpoint device may activate its receiver at that time, determine whether the message is relevant, and process the full command if applicable. The endpoint devices 110 that are not assigned to a given targeted communication interval can remain inactive during that interval, conserving energy by avoiding unnecessary receiver activations. This targeted communication structure reduces battery impact on endpoint devices 110 while increasing the number of opportunities for the communication node 120 to transmit messages.

The structured assignment of targeted communication intervals facilitates scalable and efficient operations within the communication system 100 by dividing communication opportunities across specific subsets of endpoint devices 110. For example, in a communication system 100 with 6,000 endpoint devices 110 and a periodic communication cycle of two minutes, the communication controller 130 can assign the first predefined time interval at second 30 of the first minute to facilitate synchronization of all endpoint devices of a group (e.g., those endpoints participating in the timed, synchronous reception). The remaining duration of the periodic communication cycle can include 60 targeted communication intervals distributed evenly across the second minute, with each interval assigned to a fixed subset of 100 endpoint devices 110.

The communication controller 130 can manage the assignment of targeted communication intervals in a structured manner. For example, each endpoint device 110 can be associated with a specific targeted communication interval that remains consistent across periodic communication cycles. For instance, ‘Endpoint device A’ may be assigned to second 17 of the second minute, ‘Endpoint device B’ to second 42, and ‘Endpoint device C’ to second 55. This assignment facilitates predictable and coordinated communication, allowing the communication node 120 to efficiently deliver messages to specific endpoint devices or groups.

For example, if the communication controller 130 determines that it needs to send separate messages to Endpoint devices A, B, and C, traditional MoM communication methods may require three separate transmissions, each occupying a single periodic communication cycle. Using the techniques described herein, the communication controller 130 can take advantage of targeted communication intervals. If endpoint devices A, B, and C are assigned to different targeted communication intervals (e.g., seconds 17, 42, and 55, respectively), the communication node 120 can transmit all three messages within the same periodic communication cycle by addressing each targeted interval sequentially.

As an example, in cases where two endpoint devices, such as A and B, are assigned to the same targeted communication interval, but another endpoint, such as C, is assigned to a different targeted communication interval, the communication controller 130 can improve efficiency across the system compared to traditional methods. For example, instead of requiring separate cycles for A and B, the system can use the shared synchronization interval to send a message to A and the targeted communication interval to send a message to B, allowing both messages to be delivered within a single cycle. However, if additional constraints arise—such as another endpoint (e.g., D) also being assigned to the same slot or the same interval as C—then an additional cycle may still be used. Such an approach contrasts with traditional methods, which might require three entirely separate cycles—one for each of A, B, and C.

This configuration allows the communication system 100 to efficiently complete the operation within a single periodic communication cycle (e.g., one 120-second cycle with a shared synchronization interval at second 30 and targeted intervals distributed across seconds 61-120). In some cases, depending on network demands and endpoint assignments, the operation could extend to two communication cycles. This approach significantly improves efficiency compared to traditional methods that would otherwise require three separate cycles

By structuring the targeted communication intervals and coordinating message delivery accordingly, the communication system 100 can facilitate efficient communication for large populations of endpoint devices 110. This approach can advantageously increase throughput, reduce delays, or improve energy usage across the network, while maintaining synchronization reliability and accommodating diverse communication requirements.

The communication controller 130 can be configured to manage the assignment and scheduling of communication intervals within the periodic communication cycle. This can include allocating the first predefined time interval for network-wide synchronization and command transmissions and assigning targeted communication intervals to specific subsets of endpoint devices 110. The communication controller 130 may maintain a database or mapping of endpoint devices 110 and their respective targeted communication intervals, facilitating communication with each endpoint device during its assigned interval.

In some cases, the communication controller 130 can determine the timing and content of messages to be transmitted by the communication node 120. For instance, the communication controller 130 may generate synchronization signals for transmission during the first predefined time interval or operational commands for delivery during targeted communication intervals. The communication controller 130 may prioritize certain transmissions based on network conditions, operational requirements, or endpoint device-specific factors, such as the need to update a configuration or respond to an event.

The communication controller 130 can coordinate the communication node 120 to make efficient use of the available communication intervals. For example, the communication controller 130 may identify a need to send messages to multiple endpoint devices 110 and schedule their delivery according to the targeted communication intervals assigned to those endpoint devices. In cases where multiple endpoint devices share the same targeted communication interval, the communication controller 130 can schedule messages to address those endpoint devices collectively during that interval.

In some cases, the communication controller 130 may determine that it needs to send messages to a large number of endpoint devices 110 (e.g., 100 endpoint devices) that happen to be assigned to the same targeted communication interval (e.g., second 21 of the periodic communication cycle). In such cases, the communication controller 130 may perform a routine to re-distribute the targeted communication intervals for these endpoint devices to separate some of them into different intervals. This re-distribution can facilitate faster delivery of the messages by spreading the communication load across multiple targeted communication intervals.

For example, the communication controller 130 might issue a command as the first transmission during the first predefined time interval or as a command during that targeted communication interval that instructs endpoint devices 110 currently assigned to second 21 to randomly re-assign themselves to a different targeted communication interval. This command could convey, “If your assignment is second 21, randomly select a new interval and transmit your new assignment back to me.” After receiving the responses from the affected endpoint devices, the communication controller 130 can update its internal mapping of endpoint devices 110 to reflect the new assignments. Subsequently, the communication node 120 can send messages to These endpoint devices based on the updated mapping, leveraging the improved distribution to transmit the messages more quickly across multiple targeted communication intervals.

Such an approach can reduce the time required to deliver messages to a large group of endpoint devices 110 by avoiding the need to send individual commands for re-assignment to each endpoint device. Instead, the communication controller 130 can issue a single broadcast message, enabling the endpoint device 110s to autonomously re-assign themselves and report their new targeted communication intervals. By decentralizing the re-assignment process, the communication system 100 can achieve more efficient message delivery while reducing delays and maintaining the overall energy efficiency of the network.

It will be appreciated that techniques other than random assignment may be used for re-distributing the targeted communication intervals. For instance, the communication controller 130 may use a deterministic algorithm or assign new targeted communication intervals based on pre-defined rules, such as endpoint device identifiers or operational priorities. These approaches may provide more predictable or optimized distributions, depending on the specific requirements of the communication system 100.

By managing these assignments and schedules, the communication controller 130 facilitates scalable and efficient communication across the network, supporting the transmission of synchronization signals, operational commands, and other data while maintaining energy efficiency and reducing delays. This structured coordination allows the communication system 100 to accommodate large populations of endpoint devices 110 and to adapt to varying operational demands.

The endpoint device 110 can be a utility metering or monitoring endpoint device used in applications such as water, gas, or electricity metering, or in environmental or industrial monitoring systems. For example, the endpoint device 110 can include, but is not limited to, a smart water meter, an electricity meter, a gas meter, an environmental sensor, or a communication device attached to any of these meters or sensors. The endpoint device 110 can be configured to synchronize with the communication system 100, detect and process operational commands, and optionally capture operational metrics, such as usage or environmental data, for transmission to utility or monitoring systems. The endpoint device 110 can be designed to operate over extended periods, efficiently managing communication and data collection tasks in resource-constrained environments. The endpoint device 110 may include a transceiver 112, a control circuit 114, a power source 116, and/or a sensor interface 118.

The power source 116 of the endpoint device 110 can be configured to supply energy for the operation of its components, such as the receiver, control circuit 114, and any integrated sensors. In some cases, the endpoint device 110 is battery-operated, and the power source 116 includes a battery designed to support extended functionality by adhering to energy-efficient protocols. For example, the endpoint device 110 may implement power-saving mechanisms, such as deactivating the receiver during inactive intervals, to conserve battery life. Since the receiver may consume energy when activated, managing its activation timing can be important to the operation of the endpoint device 110.

The transceiver 112 of the endpoint device 110 can facilitate communication with the communication node 120, other endpoint devices 110, and/or the communication controller 130. The transceiver 112 can include a receiver and/or a transmitter. The transceiver 112 can be transitionable between an active state and an inactive state. In the active state, the transceiver 112 can listen for transmissions from the communication node 120, such as synchronization signals or operational commands. In addition or alternatively, in the active state, the transceiver 112 can facilitate the transmission of data or responses to the communication node 120. In the inactive state, the transceiver 112 may not listen for transmissions, and thus may use less energy than when in the active state. As described herein, the transceiver 112 may be activated during predefined intervals, such as the first predefined time interval for network-wide synchronization or during targeted communication intervals assigned to the endpoint device 110. In some cases, the transceiver 112 may be activated during designated transmission intervals to send data or other messages. The control circuit 114 can manage the activation and deactivation of the transceiver 112, which can reduce energy consumption while maintaining reliable communication with the communication node 120.

The control circuit 114 can be responsible for managing various operations, including but not limited to coordinating the activation of the transceiver 112, processing received transmissions, executing operational commands, and/or coordinating transmissions from the endpoint device 110 to the communication node 120 or other components of the communication system 100. In some cases, the control circuit 114 can be implemented as, or include, a processor configured to execute computer-executable instructions for performing these functions.

In some embodiments, the control circuit 114 may determine when to activate the transceiver 112 based on predefined timing schedules associated with a periodic communication cycle. These schedules may include a first predefined time interval and one or more targeted communication intervals assigned to specific subsets of endpoint devices 110. For instance, the control circuit 114 may utilize synchronization data received in earlier communication cycles to align transceiver activation with the appropriate intervals.

During the first predefined time interval, the control circuit 114 can activate the transceiver 112 to listen for transmissions such as synchronization signals or operational commands. This interval may serve as an opportunity for network-wide communication, allowing the endpoint device 110 to synchronize its internal clock or receive general commands. Additionally, the control circuit 114 may activate the transceiver 112 during a second time interval, assigned to a specific subset of endpoint devices 110, to detect targeted transmissions. In some cases, an endpoint device 110 may be assigned to more than one targeted communication interval, in which case the control circuit 114 may activate the transceiver 112 during each of the second time intervals.

If a transmission is detected during any interval, the control circuit 114 may analyze its contents to determine whether it is directed to the endpoint device 110. For example, the control circuit 114 can compare an address or identifier included in the transmission with a stored identifier associated with the endpoint device 110. If the transmission is determined to be relevant, the control circuit 114 can maintain the transceiver 112 in an active state to process the full message and execute the associated operational command.

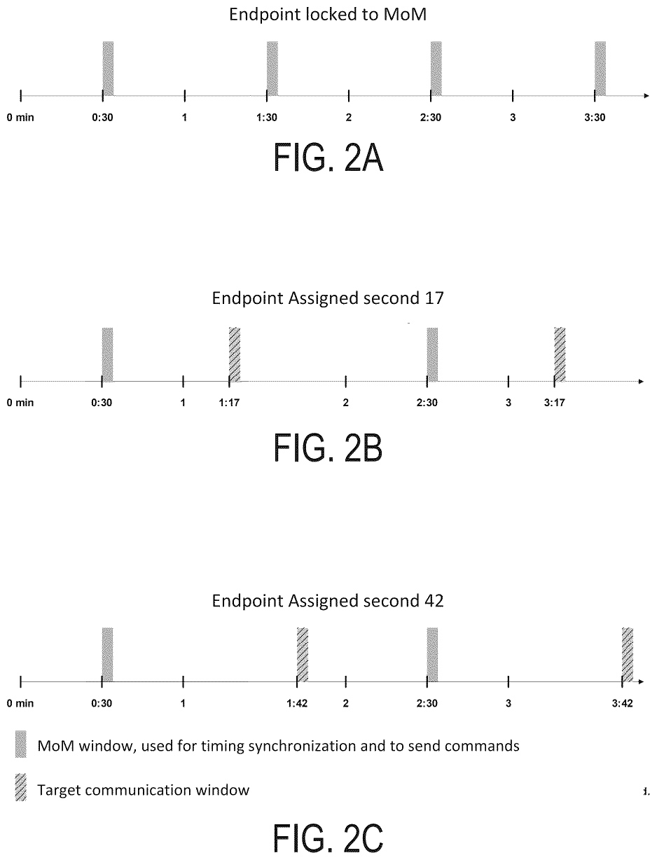

FIGS. 2A through 2C illustrate examples of a periodic communication cycle and the communication modes that can incorporate a first predefined time interval and, in some cases, additional targeted communication intervals (referred to in the figures as additional MoM windows) for communication between the communication node 120 and endpoint devices 110.

FIG. 2A illustrates a communication mode where only the first predefined time interval is used. In this mode, the first predefined time interval is assigned to occur at second 30 of each minute, providing a shared opportunity for synchronization and command delivery to all endpoint devices 110 in the group within the communication system 100. This mode aligns with traditional middle-of-minute (MoM) communication operations, where all endpoint devices 110 in the group activate their receivers at the same predefined time interval to maintain synchronization or receive operational commands.

FIGS. 2B and 2C illustrate communication modes that incorporate both the first predefined time interval and additional targeted communication intervals distributed across the periodic communication cycle. In these modes, the first predefined time interval remains assigned to second 30 of the periodic communication cycle for synchronization and general commands, while the targeted communication intervals are assigned to specific subsets of endpoint devices 110. These targeted communication intervals are distributed across the remaining duration of the periodic communication cycle, allowing the communication node 120 to address distinct subsets of endpoint devices 110 at different times.

As shown in FIG. 2B, a first endpoint device 110 is assigned a targeted communication interval at second 17 of the second minute. Similarly, FIG. 2C shows a second endpoint device 110 assigned a targeted communication interval at second 42 of the second minute. These additional targeted communication intervals enable the communication node 120 to transmit second communication messages, such as operational commands, to specific endpoint devices 110 or groups.

This structure allows the communication system 100 to increase communication opportunities significantly. For example, the communication mode shown in FIG. 2A allows only one communication opportunity per minute, resulting in two opportunities over a two-minute communication cycle. In contrast, the modes illustrated in FIGS. 2B and 2C increase the communication opportunities to 61 over the same two-minute communication cycle—one shared opportunity at second 30 of the first minute and 60 targeted communication intervals in the second minute, each addressing a specific subset of endpoint devices 110. It will be appreciated that variations in implementation may exist. For instance, in some embodiments, the MoM framework is applied every minute, with targeted timeslots distributed accordingly. This could result in 120 total communication opportunities over a two-minute communication cycle (e.g., one shared synchronization interval and 119 targeted intervals) or 60 total communication opportunities over a one-minute communication cycle (e.g., one shared synchronization interval and 59 targeted intervals).

Additionally, the use of targeted communication intervals minimizes the energy impact on endpoint devices 110. Endpoint devices not assigned to a specific targeted communication interval remain inactive during that interval, conserving energy by avoiding unnecessary receiver activations. This approach supports scalable and efficient communication across the network, allowing the communication controller 130 to balance synchronization, network-wide operations, and targeted endpoint device management without compromising energy efficiency.

### Receiver Activation and Processing in Endpoint Devices

In networked systems that include endpoint devices, such as utility meters or environmental sensors, communication frameworks help maintain synchronization and deliver operational commands. Some approaches, such as middle-of-minute (MoM) communication, schedule a shared synchronization interval at a specific point in a recurring communication cycle. For example, in a communication cycle of one minute, this interval may occur at second 30. During this shared interval, all endpoint devices within a group activate their receivers to synchronize with the network's timing and/or listen for a message. In this approach, a single message is typically sent during each communication cycle, with each message generally directed to an individual endpoint device. As a result, if multiple endpoint devices need to be addressed, each message can require a separate communication cycle. This can contribute to longer communication times and higher energy use, particularly in networks with many endpoint devices.

To address these or other challenges, the inventive concepts described herein implement a framework that integrates a shared synchronization interval with targeted communication intervals within the same periodic communication cycle. By assigning endpoint devices to specific time slots distributed across the communication cycle, the inventive concepts facilitate efficient coordination and message delivery. Endpoint devices synchronize during a shared synchronization interval and also listen for messages in their designated slot(s), with some endpoint devices potentially sharing the same slots. This approach can advantageously reduce the need for repeated use of the shared interval for individual communications and distributes communication activities evenly throughout the communication cycle.

During the shared synchronization interval, endpoint devices in the group can activate their transceivers to listen for synchronization signals or network-wide commands. These signals align internal clocks and establish a shared timing framework. When an endpoint device detects a message during this interval, it can determine whether the message is relevant by comparing an identifier in the message to its stored information. Endpoint devices for which the message is not intended may deactivate their transceivers to conserve energy, while relevant endpoint devices remain active to process the message.

Targeted communication intervals can be distributed across the communication cycle, allowing the base station to send multiple messages within a single communication cycle as needed. The base station can be configured to transmit messages frequently without significant strain on the communication system 100. For individual endpoint devices, the energy impact can be relatively minimal. For example, each endpoint device can activate its transceiver during the shared synchronization interval and any assigned targeted intervals, which may involve activating the receiver only one additional time per communication cycle. This approach can balance the ability to send multiple messages within a communication cycle with minimal additional energy usage for individual endpoint devices.

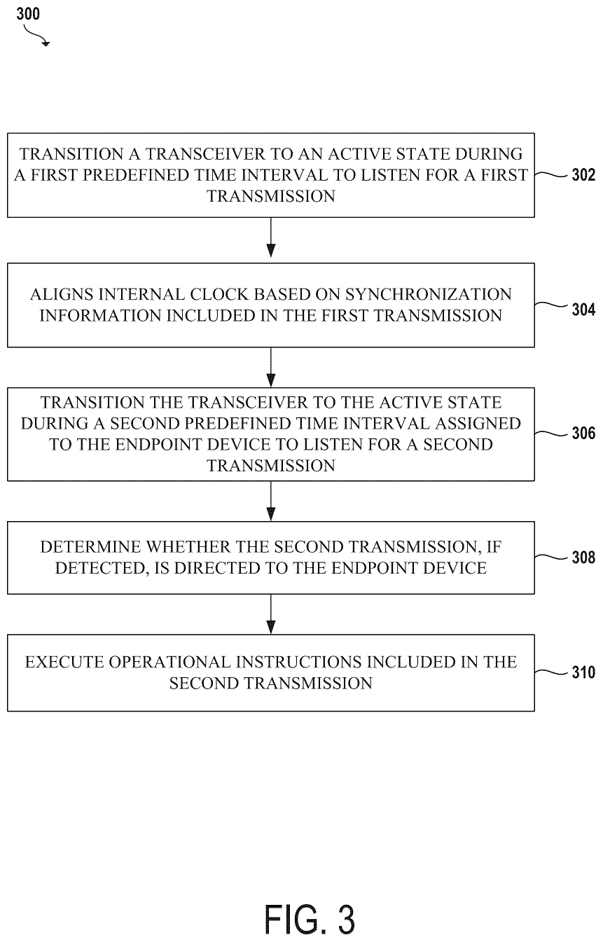

FIG. 3 presents a flow diagram illustrating an embodiment of a routine 300 implemented by the endpoint device 110 of FIG. 1. The routine 300 relates to facilitating synchronization and command reception within the periodic communication cycle. Although described as being implemented by the endpoint device 110, it will be appreciated that one or more elements of the routine 300 can be implemented by the control circuit 114, the transceiver 112, and/or other components within the communication system 100, such as the communication node 120 or the communication controller 130. Thus, the following illustrative embodiment should not be construed as limiting.

At block 302, the endpoint device 110 activates the transceiver 112 for a first predefined time interval within a periodic communication cycle. The first predefined time interval can be designated as a shared synchronization interval that facilitates network-wide communication. For example, as described herein, the first predefined time interval can be to facilitate synchronization of the internal timing of the endpoint device 110 with the network and to receive transmissions applicable to all endpoint devices in the group or to broad subsets of endpoint devices.

The first predefined time interval can be scheduled at a consistent point within each periodic communication cycle. For example, the first predefined time interval might be scheduled to last for one second, starting at second 30 of a one-minute or two-minute communication cycle. This predictability allows all endpoint devices within the group to coordinate their operations and ensure alignment with the network's timing framework. The communication node 120 can transmit signals during this interval that include synchronization information and/or general commands intended for endpoints endpoint devices.

It will be appreciated that the duration of a time slot, the location of a time slot within the communication cycle, the spacing, if any, between time slots, and the overall duration of the communication cycle can vary across embodiments. For example, in some embodiments, a time slot can last for a fraction of a second, such as 500 milliseconds, to accommodate rapid transmissions, while in other embodiments, a time slot can be extended to a second or several seconds to support larger data transfers or more complex commands. Similarly, the location of a time slot within the communication cycle can be fixed or assigned. For instance, a shared synchronization interval can occur at second 30 of a one-minute communication cycle, while targeted time slots can be distributed evenly throughout the remaining 59 seconds. In another example, a shared synchronization interval can occur at second 30 of a two-minute communication cycle, while targeted time slots can be distributed evenly throughout the 60 seconds of the second minute in the two-minute communication cycles. In other configurations, time slots can be clustered at the beginning or end of the communication cycle based on operational requirements. The spacing between time slots can also vary, with some embodiments utilizing contiguous slots for high-density communication and others incorporating gaps to allow for endpoint device processing or idle periods. Furthermore, the duration of the communication cycle itself can be adjusted based on network needs, such as one-minute communication cycles for highly responsive systems or two-minute or longer communication cycles for systems prioritizing energy conservation.

In some cases, the communication node 120 can transmit general operational commands during the first predefined time interval, in addition to or alternatively to a synchronization signal. These commands can include, but are not limited to, instructions that apply to one or multiple endpoint device 110s, such as a directive to report data or adjust a parameter. The endpoint device 110 can evaluate the content of the received message to determine its relevance. For example, it can compare an identifier in the message with stored information to assess whether the message is applicable to the endpoint device 110 itself.

If the message is determined to be relevant, the transceiver 112 can remain active to process the transmission fully. Conversely, if the message is not applicable, or if no transmission is detected during the first predefined time interval, the transceiver 112 can transition to an inactive state to conserve energy. This approach allows the endpoint device 110 to process relevant communications while reducing unnecessary power usage.

In some cases, when the transceiver 112 is activated during the first predefined time interval, the endpoint device 110 can listen for transmissions that can include a sync word. In some cases, the sync word can indicate that the message does not contain any special targeted data. In such cases, the endpoint device 110 can capture the time the sync word is received and use this information to adjust or maintain its internal clock. Since the endpoint device 110 can be configured to know the predefined timing of the sync word transmission (e.g., 333 milliseconds into second 30 of the minute), it can align its internal clock based on this reception time. Following this, the endpoint device 110 can deactivate its transceiver without receiving the rest of the message, conserving energy.

In other cases, the sync word can indicate that the message includes special targeted data. All endpoint devices 110 within the group can still use the time of the sync word's reception to align their clocks. However, they may not immediately deactivate their transceivers. Instead, each endpoint device can continue to listen until it determines whether the message is directed to it. If the message is not directed to the endpoint device, the transceiver can be deactivated to conserve energy. If the message is directed to the endpoint device, the transceiver can remain active to receive and process the full message, including any operational commands.

In some cases, this approach can allow the endpoint devices 110 to achieve efficient synchronization and clock alignment while reducing energy consumption. The system can support alternative synchronization mechanisms and is not limited to requiring a sync word.

At block 304, the endpoint device 110 aligns its internal clock based on the synchronization information included in the first transmission. This alignment ensures that the endpoint device 110 remains synchronized with the network's timing framework, allowing for efficient communication. If the first transmission includes an operational command, the endpoint device 110 can execute the instructions contained in the command. For example, the operational command might direct the endpoint device 110 to report data, update configuration parameters, or perform a specific task. If no operational command is included, the endpoint device 110 may simply update its internal clock and deactivate the transceiver to conserve energy.

In some cases, the communication node 120 may not transmit during the first predefined time interval, or the endpoint device 110 may fail to receive the transmission due to environmental factors or communication issues. In such scenarios, the endpoint device 110 may continue to operate based on its previously synchronized timing or enter a fallback mode to attempt re-synchronization in subsequent cycles. This step can ensure that the endpoint device 110 remains synchronized and operational within the network while conserving energy whenever possible. The execution of operational commands, when present, provides additional functionality and supports network-wide operations.

At block 306, the endpoint device 110 activates the transceiver 112 for a second time interval within the periodic communication cycle. This second time interval can be distinct from the first predefined time interval and can be assigned to a specific subset of endpoint device 110s, including at least the endpoint device 110 in question.

As described herein, the second time interval provides an additional opportunity for the endpoint device 110 to listen for transmissions that may be specifically directed to it. The timing of this interval can be determined based on network configuration, operational requirements, or endpoint device-specific scheduling managed by the communication node 120. By activating the transceiver 112 during the assigned time interval, the endpoint device 110 can efficiently balance its ability to receive targeted messages with conserving energy during other periods.

During the second time interval, the transceiver 112 is activated to monitor transmissions from the communication node 120, such as commands or data packets intended for individual endpoint devices or a smaller group of endpoint devices. If a transmission is detected, the endpoint device 110 can evaluate its relevance. If no transmission is detected during this interval, the transceiver 112 can be deactivated to conserve power.

At block 308, the endpoint device 110 can determine whether a detected second transmission during the assigned time interval is directed to it. Upon detecting a transmission, the endpoint device 110 can analyze the contents of the message to evaluate its relevance. This determination can involve comparing an identifier or address included in the transmission with a stored identifier or other criteria specific to the endpoint device 110.

If the identifier in the message matches the stored identifier, the endpoint device 110 can confirm that the message is intended for it. In such cases, the transceiver of the endpoint device 110 can remain in an active state to receive and process the entire message. Conversely, if the identifier does not match or the message is deemed irrelevant, the endpoint device 110 can deactivate the transceiver to conserve energy, reducing power consumption.

At block 310, the endpoint device 110 can process the second transmission if it has been determined to be relevant in block 308. In some cases, operational instructions contained in the message can be extracted and executed by the endpoint device 110. These instructions can vary depending on the intended function of the endpoint device 110 and the purpose of the transmission. For example, the instructions can direct the endpoint device 110 to report measurement data, update configuration settings, or perform diagnostic operations. The endpoint device 110 can interpret the instructions and facilitate the corresponding actions, leveraging other components of the endpoint device 110 as needed, such as sensors or memory storage.

Once the instructions are executed, the endpoint device 110 can prepare and transmit a response or acknowledgment to the communication node, depending on the nature of the operational command. Following the completion of these actions, the endpoint device 110 can transition back to an inactive state to conserve energy, returning the endpoint device 110 to low-power operation until the next relevant communication interval.

In some cases, the communication system 100 can provide adaptability by supporting the dynamic reassignment of time slots based on, for example, real-time network conditions. This capability can be beneficial in scenarios such as, but not limited to, high network loads, endpoint device failures, or changing communication requirements. For example, if multiple endpoint devices are assigned to the same targeted interval, potentially creating communication bottlenecks, the communication system 100 (e.g., the communication controller 130 and/or the communication node 120) can cause redistribution of these endpoint devices to different targeted communication intervals to balance the load. In some cases, this reassignment can occur without disrupting synchronization, as the shared interval can continue to maintain network timing. Endpoint devices can be informed of new assignments, or how to select new assignments, through broadcast messages processed during their active intervals.

In some cases, the communication system 100 can scale effectively to accommodate networks with thousands or even tens of thousands of endpoint devices 110 by utilizing structured time-slot allocation and load-balancing strategies. Each endpoint device 110 can be assigned to one or more specific time slots within the periodic communication cycle, with the total number of slots distributed across the communication cycle to improve capacity. The communication controller 130 can manage these assignments through a mapping database that tracks endpoint devices and their respective intervals, helping to avoid overlapping conflicts. In larger deployments, the communication system 100 can dynamically adjust the size and frequency of time slots to match network density. For example, high-density networks can use shorter targeted intervals to fit more slots within a communication cycle, while lower-density networks can allocate longer intervals for reliable transmission. In some cases, the communication controller 130 can implement load-balancing techniques to distribute communication demands evenly across available intervals, reducing the risk of overloading specific slots. This approach can allow the communication system 100 to maintain performance and efficiency as the network grows in size and complexity

### EXAMPLE EMBODIMENTS

Embodiments of the present disclosure can be described in view of the following clauses:

Clause 1. An endpoint device configured for operation within a communication network, the endpoint device comprising:
a receiver configurable to transition between an active state and an inactive state, wherein in the active state the receiver is configured to detect transmissions from a communication node, and wherein in the inactive state the receiver is not configured to detect transmissions from the communication node;
a power source configured to supply power to the receiver; and
a control circuit configured to:
   activate the receiver for a first predefined time interval within a periodic communication cycle, the first predefined time interval being the same for all endpoint devices in a group of endpoint devices within the communication network, during which all endpoint devices in the group activate respective receivers to receive a first transmission from a base station; and
   activate the receiver for a second time interval within the periodic communication cycle, the second time interval being distinct from the first predefined time interval and being assigned to a subset of the group of endpoint devices that includes the endpoint device, wherein the receiver listens during the second time interval to detect a presence of a second transmission from the base station,
   wherein if the second transmission is detected during the second time interval, the control circuit determines whether the second transmission is directed to the endpoint device and, if so, maintains the receiver in an active state to receive and process the second transmission; and
   wherein if no transmission is detected during the second time interval or if the second transmission is not directed to the endpoint device, the control circuit deactivates the receiver.

Clause 2. The endpoint device of clause 1, wherein the control circuit is configured to:
detect the presence of the second transmission during the second time interval;
determine that the second transmission is directed to the endpoint device; and
maintain the receiver in the active state to receive and process the second transmission.

Clause 3. The endpoint device of clause 2, wherein, to determine that the second transmission is directed to the endpoint device, the control circuit is configured to:
analyze an address or identifier included in the second transmission;
compare the address or identifier to a stored address or identifier associated with the endpoint device; and
determine that the second transmission is directed to the endpoint device when the address or identifier in the second transmission matches the stored address or identifier.

Clause 4. The endpoint device of clause 3, wherein the control circuit is configured to:
detect the presence of the second transmission during the second time interval;
determine that the second transmission is not directed to the endpoint device; and
deactivate the receiver upon determining that the second transmission is not directed to the endpoint device.

Clause 5. The endpoint device of clause 3, wherein the control circuit is configured to:
process the second transmission to extract a command intended for the endpoint device; and
execute the command to perform a function associated with the endpoint device.

Clause 6. The endpoint device of any of the preceding clauses, wherein the second transmission comprises a command instructing the endpoint device and other endpoint devices in the subset of the group of endpoint devices to select new second time intervals, and wherein the control circuit is configured to:
select a new second time interval for the endpoint device from a set of available time intervals in response to the command, the selection being configured to reduce overlap of time intervals among the subset of endpoint devices;
update the second time interval of the endpoint device based on the selection; and
generate and cause transmission of an indication of the new second time interval to the communication node.

Clause 7. The endpoint device of clause 6, wherein the second transmission comprises an instruction to select a different second time interval based on network load or time interval collisions, and wherein the control circuit is configured to:
select a new second time interval in response to the instruction; and
update the second time interval of the endpoint device to the new second time interval.

Clause 8. The endpoint device of any of the preceding clauses, wherein the control circuit is configured to: determine that no second transmission is present during the second time interval; and deactivate the receiver based on a determination that no second transmission is present.

Clause 9. The endpoint device of any of the preceding clauses, wherein the first transmission comprises synchronization information or a command.

Clause 10. The endpoint device of clause 9, wherein the first transmission comprises synchronization information, and wherein the control circuit is configured to update a temporal alignment of the endpoint device with the communication network based on the synchronization information.

Clause 11. The endpoint device of clause 9, wherein the first transmission comprises a command, and wherein the control circuit is configured to determine whether the operational command is directed to the endpoint device, wherein based on a determination that the operational command is directed to the endpoint device, the control circuit maintains the receiver in an active state to receive an entirety of the first transmission, and wherein based on a determination that the operational command is not directed to the endpoint device, the control circuit deactivates the receiver.

Clause 12. The endpoint device of any of the preceding clauses, wherein the periodic communication cycle comprises a duration of about 60 seconds, wherein the first predefined time interval has a duration of about 166 milliseconds within each periodic communication cycle, and wherein the second time interval is assigned within a remaining duration of the periodic communication cycle and has a duration of about 166 milliseconds.

Clause 13. The endpoint device of any of the preceding clauses, wherein the power source is battery or a solar cell.

Clause 14. A method for operating an endpoint device within a communication network, the method comprising:
activating a receiver of the endpoint device for a first predefined time interval within a periodic communication cycle, the first predefined time interval being the same for all endpoint devices in a group of endpoint devices within the communication network, during which all endpoint devices in the group activate respective receivers to receive a first transmission from a communication node;
activating the receiver for a second time interval within the periodic communication cycle, the second time interval being distinct from the first predefined time interval and being assigned to a subset of the group of endpoint devices that includes the endpoint device, wherein the receiver listens during the second time interval to detect a presence of a second transmission from the communication node;
wherein, if the second transmission is detected during the second time interval, it is determined whether the second transmission is directed to the endpoint device and, if so, the receiver is maintained in an active state to receive and process the second transmission; and
wherein, if no transmission is detected during the second time interval or if the detected second transmission is not directed to the endpoint device, the receiver is deactivated.

Clause 15. The method of clause 14, further comprising:
detecting the presence of the second transmission during the second time interval;
determining that the second transmission is directed to the endpoint device; and
maintaining the receiver in the active state to receive and process the second transmission.

Clause 16. The method of any of clauses 14 or 15, wherein determining that the second transmission is directed to the endpoint device comprises:
analyzing an address or identifier included in the second transmission;
comparing the address or identifier to a stored address or identifier associated with the endpoint device; and
determining that the second transmission is directed to the endpoint device when the address or identifier in the second transmission matches the stored address or identifier.

Clause 17. The method of any of clauses 14 to 16, further comprising:
determining that no second transmission is present during the second time interval; and
deactivating the receiver based on the determination that no second transmission is present.

Clause 18. The method of any of clauses 14 to 17, wherein the first transmission comprises synchronization information or a command,
wherein, if the first transmission comprises synchronization information, a temporal alignment of the endpoint device with the communication network is updated based on the synchronization information,
wherein, if the first transmission comprises a command, it is determined whether the operational command is directed to the endpoint device and, based on a determination that the operational command is directed to the endpoint device, the receiver is maintained in an active state to receive an entirety of the first transmission, and
wherein, based on a determination that the operational command is not directed to the endpoint device, the receiver is deactivated.

Clause 19.A non-transitory computer-readable medium storing instructions that, when executed by a processor of an endpoint device operating within a communication network, cause the endpoint device to:
activate a receiver for a first predefined time interval within a periodic communication cycle, the first predefined time interval being the same for all endpoint devices in a group of endpoint devices within the communication network, during which all endpoint devices in the group activate respective receivers to receive a first transmission from a base station; and
activate the receiver for a second time interval within the periodic communication cycle, the second time interval being distinct from the first predefined time interval and being assigned to a subset of the group of endpoint devices that includes the endpoint device, wherein the receiver listens during the second time interval to detect a presence of a second transmission from the base station,
wherein if the second transmission is detected during the second time interval, the processor determines whether the second transmission is directed to the endpoint device and, if so, maintains the receiver in an active state to receive and process the second transmission; and
wherein if no transmission is detected during the second time interval or if the detected second transmission is not directed to the endpoint device, the processor deactivates the receiver.

Clause 20. The non-transitory computer-readable medium of clause 19, wherein the instructions further cause the endpoint device to:
receive a second transmission comprising a command instructing the endpoint device and other endpoint devices in a subset of the group of endpoint devices to select new second time intervals;
select a new second time interval for the endpoint device from a set of available time intervals in response to the operational command;
update the second time interval of the endpoint device to the new second time interval; and
generate and transmit an indication of the new second time interval to a communication node.

### Terminology

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may include, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. An endpoint device configured for operation within a communication network, the endpoint device comprising:
a receiver configurable to transition between an active state and an inactive state, wherein in the active state the receiver is configured to detect transmissions from a communication node, and wherein in the inactive state the receiver is not configured to detect transmissions from the communication node;
a power source configured to supply power to the receiver; and
a control circuit configured to:
activate the receiver for a first predefined time interval within a periodic communication cycle, the first predefined time interval being the same for all endpoint devices in a group of endpoint devices within the communication network, during which all endpoint devices in the group activate respective receivers to receive a first transmission from a base station; and
activate the receiver for a second time interval within the periodic communication cycle, the second time interval being distinct from the first predefined time interval and being assigned to a subset of the group of endpoint devices that includes the endpoint device, wherein the receiver listens during the second time interval to detect a presence of a second transmission from the base station,
wherein if the second transmission is detected during the second time interval, the control circuit determines whether the second transmission is directed to the endpoint device and, if so, maintains the receiver in an active state to receive and process the second transmission; and
wherein if no transmission is detected during the second time interval or if the second transmission is not directed to the endpoint device, the control circuit deactivates the receiver.

2. The endpoint device of claim 1, wherein the control circuit is configured to:
detect the presence of the second transmission during the second time interval;
determine that the second transmission is directed to the endpoint device; and
maintain the receiver in the active state to receive and process the second transmission.

3. The endpoint device of claim 2, wherein, to determine that the second transmission is directed to the endpoint device, the control circuit is configured to:
analyze an address or identifier included in the second transmission;
compare the address or identifier to a stored address or identifier associated with the endpoint device; and
determine that the second transmission is directed to the endpoint device when the address or identifier in the second transmission matches the stored address or identifier.

4. The endpoint device of claim 3, wherein the control circuit is configured to:
detect the presence of the second transmission during the second time interval;
determine that the second transmission is not directed to the endpoint device; and
deactivate the receiver upon determining that the second transmission is not directed to the endpoint device.

5. The endpoint device of claim 3, wherein the control circuit is configured to:
process the second transmission to extract a command intended for the endpoint device; and
execute the command to perform a function associated with the endpoint device.

6. The endpoint device of claim 1, wherein the second transmission comprises a command instructing the endpoint device and other endpoint devices in the subset of the group of endpoint devices to select new second time intervals, and wherein the control circuit is configured to:
select a new second time interval for the endpoint device from a set of available time intervals in response to the command, the selection being configured to reduce overlap of time intervals among the subset of endpoint devices;
update the second time interval of the endpoint device based on the selection; and
generate and cause transmission of an indication of the new second time interval to the communication node.

7. The endpoint device of claim 6, wherein the second transmission comprises an instruction to select a different second time interval based on network load or time interval collisions, and wherein the control circuit is configured to:
select a new second time interval in response to the instruction; and
update the second time interval of the endpoint device to the new second time interval.

8. The endpoint device of claim 1, wherein the control circuit is configured to:
determine that no second transmission is present during the second time interval; and
deactivate the receiver based on a determination that no second transmission is present.

9. The endpoint device of claim 1, wherein the first transmission comprises synchronization information or a command.

10. The endpoint device of claim 9, wherein the first transmission comprises synchronization information, and wherein the control circuit is configured to update a temporal alignment of the endpoint device with the communication network based on the synchronization information.

11. The endpoint device of claim 9, wherein the first transmission comprises a command, and wherein the control circuit is configured to determine whether the operational command is directed to the endpoint device, wherein based on a determination that the operational command is directed to the endpoint device, the control circuit maintains the receiver in an active state to receive an entirety of the first transmission, and wherein based on a determination that the operational command is not directed to the endpoint device, the control circuit deactivates the receiver.

12. The endpoint device of claim 1, wherein the periodic communication cycle comprises a duration of about 60 seconds, wherein the first predefined time interval has a duration of about 166 milliseconds within each periodic communication cycle, and wherein the second time interval is assigned within a remaining duration of the periodic communication cycle and has a duration of about 166 milliseconds.

13. The endpoint device of claim 1, wherein the power source is battery or a solar cell.

14. A method for operating an endpoint device within a communication network, the method comprising:
activating a receiver of the endpoint device for a first predefined time interval within a periodic communication cycle, the first predefined time interval being the same for all endpoint devices in a group of endpoint devices within the communication network, during which all endpoint devices in the group activate respective receivers to receive a first transmission from a communication node;
activating the receiver for a second time interval within the periodic communication cycle, the second time interval being distinct from the first predefined time interval and being assigned to a subset of the group of endpoint devices that includes the endpoint device, wherein the receiver listens during the second time interval to detect a presence of a second transmission from the communication node;
wherein, if the second transmission is detected during the second time interval, it is determined whether the second transmission is directed to the endpoint device and, if so, the receiver is maintained in an active state to receive and process the second transmission; and
wherein, if no transmission is detected during the second time interval or if the detected second transmission is not directed to the endpoint device, the receiver is deactivated.

15. The method of claim 14, further comprising:
detecting the presence of the second transmission during the second time interval;
determining that the second transmission is directed to the endpoint device; and
maintaining the receiver in the active state to receive and process the second transmission.

16. The method of claim 15, wherein determining that the second transmission is directed to the endpoint device comprises:
analyzing an address or identifier included in the second transmission;
comparing the address or identifier to a stored address or identifier associated with the endpoint device; and
determining that the second transmission is directed to the endpoint device when the address or identifier in the second transmission matches the stored address or identifier.

17. The method of claim 14, further comprising:
determining that no second transmission is present during the second time interval; and
deactivating the receiver based on the determination that no second transmission is present.

18. The method of claim 14, wherein the first transmission comprises synchronization information or a command,
wherein, if the first transmission comprises synchronization information, a temporal alignment of the endpoint device with the communication network is updated based on the synchronization information,
wherein, if the first transmission comprises a command, it is determined whether the operational command is directed to the endpoint device and, based on a determination that the operational command is directed to the endpoint device, the receiver is maintained in an active state to receive an entirety of the first transmission, and
wherein, based on a determination that the operational command is not directed to the endpoint device, the receiver is deactivated.

19. A non-transitory computer-readable medium storing instructions that, when executed by a processor of an endpoint device operating within a communication network, cause the endpoint device to:
activate a receiver for a first predefined time interval within a periodic communication cycle, the first predefined time interval being the same for all endpoint devices in a group of endpoint devices within the communication network, during which all endpoint devices in the group activate respective receivers to receive a first transmission from a base station; and
activate the receiver for a second time interval within the periodic communication cycle, the second time interval being distinct from the first predefined time interval and being assigned to a subset of the group of endpoint devices that includes the endpoint device, wherein the receiver listens during the second time interval to detect a presence of a second transmission from the base station,
wherein if the second transmission is detected during the second time interval, the processor determines whether the second transmission is directed to the endpoint device and, if so, maintains the receiver in an active state to receive and process the second transmission; and
wherein if no transmission is detected during the second time interval or if the detected second transmission is not directed to the endpoint device, the processor deactivates the receiver.

20. The non-transitory computer-readable medium of claim 19, wherein the instructions further cause the endpoint device to:
receive a second transmission comprising a command instructing the endpoint device and other endpoint devices in a subset of the group of endpoint devices to select new second time intervals;
select a new second time interval for the endpoint device from a set of available time intervals in response to the operational command;
update the second time interval of the endpoint device to the new second time interval; and
generate and transmit an indication of the new second time interval to a communication node.
